(19) United States
(12) Patent Application Publication
(10) Pub. No.: US 2022/0240492 A1
(43) Pub. Date: Aug. 4, 2022

(54) FISHING LURE

(71) Applicant: KYLE BOLDT, THODE (CA)

(72) Inventor: KYLE BOLDT, THODE (CA)

(21) Appl. No.: 17/548,495

(22) Filed: Dec. 11, 2021

(30) Foreign Application Priority Data
Dec. 12, 2020 (CA) 3102560

(51) Int. Cl. A01K 83/06; A01K 85/00

(52) U.S. Cl. CPC A01K 83/06; A01K 85/1833

(57) ABSTRACT

A novel fishing lure that includes a component to secure bait to the hook and to reduce the likelihood of the bait falling off the hook during the course of a fishing activity. The lure includes a body, a hook and a bait securing arm that cooperate to secure the bait to the hook.

### CLAIM OF PRIORITY

This application claims priority to and the benefit of Canadian Patent Application 3,102,560 filed on Dec. 12, 2020, with the title FISHING LURE, which is hereby incorporated by reference in its entirety.

### FIELD OF THE INVENTION

The invention is in the field of sporting goods, in particular fishing lures.

### BACKGROUND

In the activity of recreational fishing, it is common practice to attach bait to a hook as an enticement to fish that one wishes to catch. One of the problems with simply attaching bait to a hook is that a single point of attachment is not very secure, and bait can either fall off the hook during the process of casting, jigging, or reeling in line. This requires the need to re-bait the hook, with no guarantees that the result will be any more favorable in terms of keeping the hook baited until a fish strikes at it.

There have been attempts to better secure bait to lures, including examples such as that in US Pat. No. 3,863,383 (Lore). That patent discloses the use of a hook that include two washers placed on the shank of the hook, and an arrangement whereby the fishing line that is attached to the hook creates a compressive force that squeezes the bait between the two washers. However, this solution suffers from several limitations, including that force applied to the fishing line could cause sufficient crushing force resulting in the severing of the bait, at which point it would fall off the hook assembly and be lost.

### SUMMARY OF THE INVENTION

The invention of the present disclosure comprises a novel fishing lure that includes a component to secure bait to the hook and to reduce the likelihood of the bait falling off the hook during the course of a fishing activity. The lure includes a body, a hook and a bait securing arm that cooperate to secure the bait to the hook.

### FIGURES

FIG. 1 depicts a layout view of the components of an embodiment of a fishing lure according to the present disclosure.

FIG. 2 depicts a side view of the assembled components of a fishing lure of the present disclosure.

FIG. 3 depicts a side view of a fishing lure of the present invention in which bait has been secured to the lure.

### DETAILED DESCRIPTION OF THE INVENTION

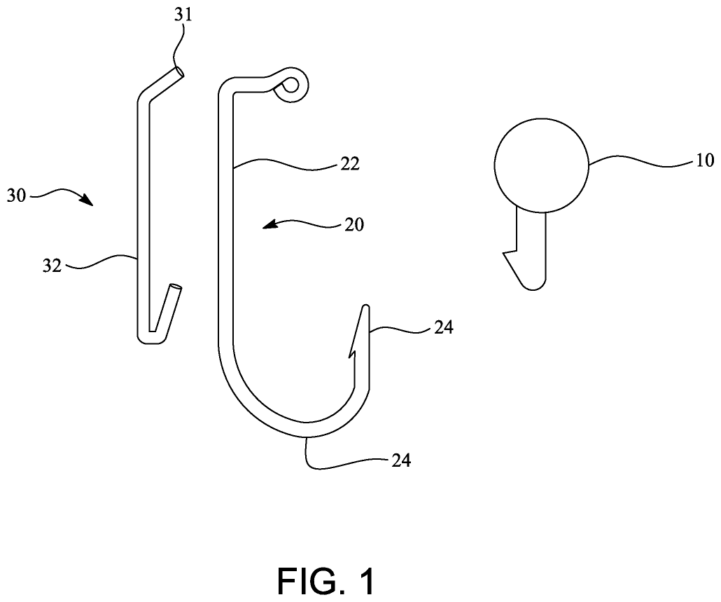

The fishing lure 1 of the present disclosure in one embodiment comprises three components, a body 10, a fishhook 20, and a bait hook 30. The separate components are depicted in FIG. 1.

As shown in FIG. 1, the fishhook 20 will comprise an eye portion 21, adapted to be secured to a length of fishing line, a shaft portion 22, connecting the eye portion to the hook portion 23 of the fishhook. The hook portion may also include one or more barbs 24, as are commonly found in fishhooks. In some embodiments the hook may comprise one, two, three or more barbs as desired, all connected to the shaft portion.

The bait hook comprises a body attachment 31, a shaft 32, and a hooked region 33. The body attachment may be bent at an angle relative to the shaft of the bait hook, and the angle may vary depending on how the user wishes to position the bait hook relative to the fishhook. In one embodiment, depicted in the figures, the angle formed between the body attachment and the shaft of the bait hook is approximately 45°. Other bend angles may be used as desired without departing form the scope of the invention, and the angle of the bend between the body attachment and the shaft of the bait hook is not considered to be limiting to the scope of the invention. The hooked region 33 is also bent relative to the shaft and is adapted to provide a structure to secure the bait to the lure, either in cooperation with the fishhook or independently. The angle of the bend in the illustrated embodiment in the figures is approximately 60° but other angles are useful as well. In general, the angle formed between the hooked region and the shaft of the bait hook will be less than 90°.

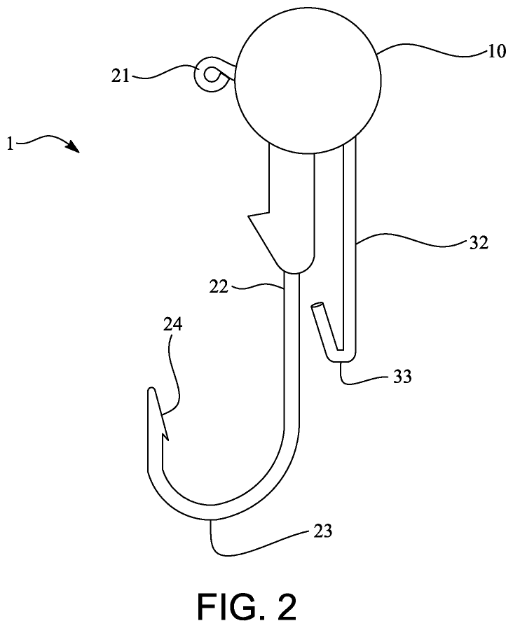

In one embodiment, depicted in FIG. 2, when assembled, the fishhook and bait hook are each attached to the body of the lure. The body can be of various shapes, and comprise various colors and markings to make it more attractive to fish. The specific shape, color and/or markings present on the body can be varied depending on the type of fish being fished for, and the types of colors shapes and marking that species of fish would be most likely to be attracted to.

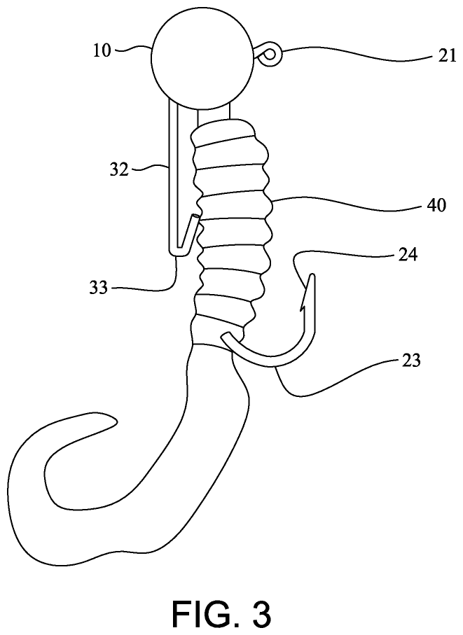

In the illustrated embodiments, the fishhook and bait hook will be attached to the body such that the hook portions of each of the fishhook and bait hook will be oriented in the same direction, as shown in FIG. 2. Conveniently, this arrangement permits easy securement of bait 40, as depicted in FIG. 3. In one example, and as shown in FIG. 3, the fishhook can be used to puncture through the bait, and a portion of the bait passed up to encase the majority of the length of the shaft of the fishhook. Once in place, the bait can then also be manipulated to engage the bait hook, thus securing the bait in place, and substantially reducing the likelihood of losing the bait during the action of fishing. The fishing technique used with the lure can be one of casting, jigging, and trolling.

It will be apparent to those skilled in the art that many more modifications besides those already described are possible without departing from the inventive concepts herein. For example, it will be realized that the optimal dimensions for the various parts of the invention, materials, shape, form, manner of assembly, and operation or use will be apparent to those of skill in the art. The inventive subject matter, therefore, is not to be restricted except in the scope of any claims as may be directed to the disclosure presented herein. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. All suitable modifications and equivalents that may be resorted to are thereby considered to be within the scope of the present invention.

What is claimed is:

1. A fishing lure adapted to substantially prevent loss of a fishing bait from the lure during a fishing operation, the lure comprising:
a. a body, a fishhook and a bait hook, the fishhook and bait hook secured to the body to complete the assembled lure;
i. wherein the fishhook comprises an eye adapted for attaching to a length of fishing line, a hook, and a shaft connecting the eye and hook of the fishhook;
ii. wherein the bait hook comprises a body attachment, a hook and a shaft connecting the body attachment to the bait hook; and
iii. wherein the bait hook and fishhook are attached to the body in such a manner as to cooperate in securing the fishing bait to the lure, thereby reducing the risk of loss of the fishing bait during a fishing operation.

2. The fishing lure of claim 1, wherein a portion of the shaft of the fishhook is encased by the body, and the eye of the fishhook is exposed to permit attachment to a length of fishing line.

3. The fishing lure of claim 1, wherein the fishhook and bait hook are oriented such they extend substantially in the same direction from the body of the lure, and wherein the hook portions of each of the fishhook and bait hook are pointing in substantially the same direction.

4. The fishing lure of claim 1 wherein the body comprises a specific shape, color and markings attractive to a particular species of fish.

5. The fishing lure of claim 1, wherein the fishing activity comprises one of casting, jigging and trolling.

6. The fishing lure of claim 1, wherein the fishhook has one, two, three or more barbed hooks.
